(19) United States
(12) Patent Application Publication
(10) Pub. No.: US 2013/0094203 A1
(43) Pub. Date: Apr. 18, 2013

(54) RETROFIT ASSEMBLY FOR FLUORESCENT LIGHT FIXTURES

(71) Applicant: ECO LIGHTING LLC, Miami, FL (US)

(72) Inventor: ANTHONY MANGIARACINA, SHARPSBURG, AL (US)

(73) Assignee: ECO LIGHTING LLC, MIAMI, FL (US)

(21) Appl. No.: 13/654,739

(22) Filed: Oct. 18, 2012

Related U.S. Application Data
(60) Provisional application No. 61/548,452, filed on Oct. 18, 2011.

(51) Int. Cl. F21V 21/00; F21V 19/00

(52) U.S. Cl. 362/225; 362/217.17

(57) ABSTRACT

A retrofit assembly and kit provide for the retrofitting of a low-frequency T12 fluorescent light fixture with a magnetic ballast with high-efficiency high-frequency T5 fluorescent bulbs. Since the lumen output of the T5 retrofit lamp is greater than that of the equivalent T12 bulb, and typically more than desired, there is provided a dummy bulb which bridges one pair of terminals without being active as a lighting unit. The delamping link dummy bulb is provided with a bank of series-connected capacitors connected between the power pins of the pair of terminals. The dummy link may also be used to replace a T12 bulb where the lumen output of the fixture is more than desired.

### CROSS-REFERENCE TO RELATED APPLICATION

This application claims the benefit, under 35 U.S.C. §119(e), of provisional patent application No. 61/548,452, filed Oct. 18, 2011; the prior application is herewith incorporated by reference in its entirety.

### BACKGROUND OF THE INVENTION

### Field of the Invention

The invention pertains to fluorescent lighting systems and, more particularly, to a system for the conversion of fluorescent light fixtures in terms of the lumen output and to the conversion of systems with magnetic ballasts to newer high-frequency systems and intelligent systems.

Fluorescent light bulbs are superior, in terms of energy efficiency, over incandescent light bulbs. The latter generate light by way of a resistance element that resists the electrical current to such an extent that the element starts to visibly glow. This generates heat, which is considered wasted energy in terms of the lighting efficiency. Fluorescent light bulbs use a gas to generate light. The gas is excited by the electrical power to generate light in the UV range. The UV light impinges on the coating of the bulb, which converts the UV light to visible light. Due to the fact that fluorescent light bulbs do not convert the electricity to heat, they are more efficient than incandescent light bulbs.

If fluorescent light bulbs were left without proper energy control, the gas would continue to gain in intensity until the light extinguishes. For that purpose, the fluorescent light bulb lighting systems use a so-called ballast. The ballast has two primary purposes, namely, to supply the initial energy (i.e., a jolt) to start the light generation—and to heat the cathode in some cases—and then to regulate the current flowing through the fixture at the proper level. Older systems use a magnetic ballast (they are called magnetic ballasts because they use an inductor as the reactive component) which leads to a power loss of approximately 5 to 25%. Newer systems use an electronic ballast with solid state circuitry. These are also called high-frequency ballasts, because they raise the mains frequency of 50 or 60 Hz to approximately 20 kHz or higher. Besides the fact that the low frequency flicker is eliminated by raising the frequency, the efficiency of the lamps is also improved by a factor of approximately 10% or more.

Fluorescent light bulbs come in different shapes and sizes. The most popular shapes are straight cylindrical tubes of different lengths and diameters. The diameter of the tube is referenced in the name of the fluorescent light bulb, namely, T12, T10, T8, and T5. The numerical indicator refers to one eighth (⅛) of an inch. The T5 tube has a diameter of ⅝ inches, the T8 tube has a diameter of 1 inch ( 8/8), the T10 tube has a diameter of 1 and ¼ inches ( 10/8), and the T12 tube has a diameter of 1.5 inches ( 12/8). The fluorescent light bulbs, besides their physical dimensions, also come in a vast variety of power output and light temperature specifications. The light temperature ranges from below 3000 Kelvin to above 6500 Kelvin.

In the context of the straight cylindrical tubes to which the invention pertains, T5 lamps are slightly shorter than T12 lamps. That is, the T12, by way of example, is 1200 mm long while the corresponding-length T5 tube is 1148 mm long. They can only be used as replacements for the larger lamps by adding an adapter. Most luminaires are easily converted from T12 to T5 by changing a socket and the ballast.

Commonly assigned U.S. Pat. No. 7,936,129 B2 describes a converter assembly which connects between the terminals of the luminaire socket and the lamp terminals. The assembly is formed so as to bridge the spacing to the shorter tube as the T12 is replaced by a T8 and/or T5 lamp, for example. The magnetic ballast of the T12 lamp is bypassed, and the power signal is up-converted to the higher frequency so as to power the high-frequency lamp. The earlier patent is herewith incorporated by reference.

The primary advantages of the newer tubes, such as T8 and T5, is that they consume less power. The energy usage of a T8 bulb is 32 W while the corresponding T12 bulb uses 40 W. The luminous efficacy (i.e., lumens per watt, LMW) of a T12 with magnetic ballast is rated at approx. 60, while the LMW of a T5 tube ranges between 70 and 100. In addition, the T12 bulbs “decay” over time, for instance by about 10% after 7000 hours of use, while the decay of the T5 bulb is nearly negligible.

The T5 fluorescent bulb is the generally most desirable generic fluorescent light bulb. Its higher cost is easily outweighed, in most contexts, by its superior performance. Several factors are taken into account, namely, the quality of the light, which is measured in a color rendering index (CRI), the lumen output relative to the power consumption, measured in lumens-per-watt (LPW), and the co-efficiency of utilization (CU). The T5 is superior in all three categories, and it shines especially in the power efficiency category LPW.

Replacing a T12 with a T5, therefore, often has an unintended consequence: the lumen output of the T5-equipped lighting fixture is much higher than that of the T12-equipped fixture. In other words, the fixture becomes too bright after the conversion and it becomes desirable to dial down the lumen output of the fixture.

### BRIEF SUMMARY OF THE INVENTION

It is accordingly an object of the invention to provide an adapter and retrofit assembly which overcomes the above-mentioned disadvantages of the heretofore-known devices and methods of this general type and which enables and simplifies the conversion of the prior fluorescent lighting systems with magnetic ballast start to newer, high-frequency systems with improved energy efficiency and a further conversion to systems for integration in more “intelligent” lighting systems.

With the foregoing and other objects in view there is provided, in accordance with the invention, a retrofit assembly for installing a high-frequency fluorescent lamp in a multi-bulb light fixture provided with first terminals for a first light bulb and second terminals for a second light bulb, the assembly comprising:
a high-frequency fluorescent bulb configured with physical dimensions to fit into the multi-bulb light fixture for connection to the first terminals of the multi-bulb light fixture;
a dummy bulb configured with physical dimensions to fit into the multi-bulb light fixture for connection to the second terminals of the multi-bulb light fixture, the dummy bulb having a bridging circuit connecting the second terminals to one another.

In accordance with an added feature of the invention, the high-frequency fluorescent bulb is a T5 fluorescent bulb with rapid start capability.

In accordance with an added feature of the invention, the T5 fluorescent bulb includes one or two end piece adapters for lengthening an effective length of the T5 fluorescent bulb to an equivalent length of a T12 fluorescent bulb.

In accordance with an added feature of the invention, the dummy bulb has a length corresponding to an equivalent length of a T12 fluorescent bulb.

In accordance with an added feature of the invention, the bridging circuit comprises a series circuit of a plurality of capacitors connected in series between respective power terminals of the second terminals.

With the above and other objects in view there is also provided, in accordance with the invention, a delamping dummy bulb for installation in a multi-tube fluorescent light fixture configured for bi-terminal T12 fluorescent bulbs. The delamping dummy bulb comprises:
a first terminal having at least one terminal pin for connection to a power terminal of the light fixture, a second terminal having at least one terminal pin for connection to a power terminal of the light fixture, and a connecting body extending between and connecting the first and second terminals at a relative position corresponding to a relative position of first and second terminals of a T12 fluorescent bulb;
a bridging circuit electrically connected between the terminal pin of the first terminal and the terminal pin of the second terminal, the bridging circuit including a plurality of capacitors connected in series between the first and second terminals.

In accordance with a concomitant feature of the invention, the capacitors of the bridging circuit are dimensioned to provide an equivalent resistance to a driving ballast of the light fixture when the delamping dummy is installed in place of a T12 fluorescent bulb.

By way of definition, when referring to a “multi-bulb” fixture, the intent here is to refer to a lighting fixture for at least two or more discrete bulbs. That is, since each lamp requires two (two-prong) terminals, the multi-bulb fixture will be equipped with four, or six, or eight, or more terminals. The term “bulb,” while generally referring to a straight, cylindrical bulb or any of the rated lengths, also includes free-form, curved, bent, or helically wound fluorescent light bulbs.

Also by way of definition, the term “low frequency” is understood to refer to a frequency below, say, 1000 Hz (<1 kHz) and the term “high frequency” is understood to refer to frequencies above 1000 Hz (>1 kHz). In general, high-frequency lamps to which this specification refers are operated at frequencies of 20 kHz and above.

The adapter and retrofit assembly according to the invention is designed to adapt the 1200 mm long T8 lamp to the 1148 mm long T5 lamp. Furthermore the adapter assembly may include an electronic circuit that converts the T8 high frequency instant start ballast (or even the T12 high frequency instant start/rapid start ballast) to T5 rapid start ballast or T5 programmed start ballast.

Additional information with regard to drive electronics for the light fixtures and the electronic system for converting the less efficient systems is found in our co-pending patent application No. 13/447,720, filed Apr. 16, 2012 and in our international patent application PCT/US12/29732, filed Mar. 20, 2012; the prior applications are herewith incorporated by reference.

In some of the conversions for the older T12 systems to the newer T5 systems, the retrofitted light fixture outputs more lumen—that is, it is brighter—than before the conversion. This “problem” may be solved by installing the retrofit assembly according to the invention, which provides for one or more active bulbs and one or more dummy bulbs. The same “dimming” effect is achieved when one or more T12 light bulbs or a multi-bulb fixture are replaced by one or more dummies.

The novel retrofit assembly works with all fluorescent fixtures, from 2 feet to 8 feet and it may include circuit bridging adapters if necessary.

Other features which are considered as characteristic for the invention are set forth in the appended claims.

Although the invention is illustrated and described herein as embodied in a retrofit assembly for fluorescent light fixtures, it is nevertheless not intended to be limited to the details shown, since various modifications and structural changes may be made therein without departing from the spirit of the invention and within the scope and range of equivalents of the claims.

The construction of the invention, however, together with additional objects and advantages thereof will be best understood from the following description of the specific embodiment when read in connection with the accompanying drawings.

### BRIEF DESCRIPTION OF THE SEVERAL VIEWS OF THE DRAWING

FIG. 1 is a schematic side view of a dummy assembly according to the invention; and

FIG. 2 is a plan view of a lighting fixture in a troffer with a T5 fluorescent lamp and a dummy lamp installed.

### DESCRIPTION OF A PREFERRED EMBODIMENT OF THE INVENTION

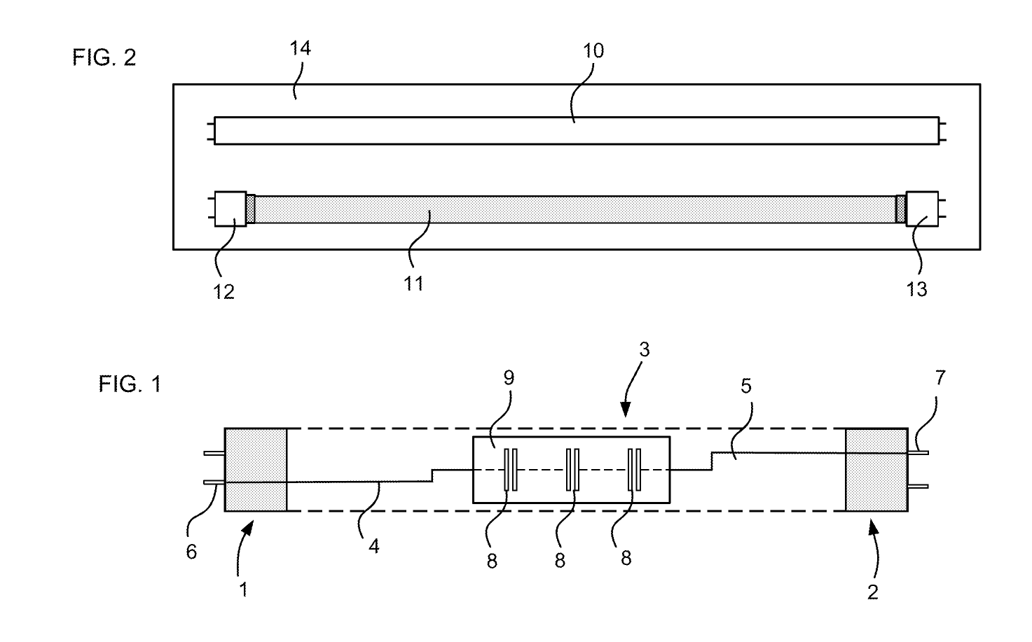

Referring now to the figures of the drawing in detail and first, particularly, to FIG. 1 thereof, there is seen a dummy bulb assembly according to the invention. The dummy is also referred to as a delamping link, as it provides for a bridging circuit in place of a bulb that has been removed. The dummy bulb may be provided for two different purposes. One such purpose is to replace a T12 bulb while other T12 bulbs are still active in the light fixture. For example, when a multi-bulb fixture outputs more light than desired, any number of active lights may be removed and replaced with the dummy bulb. This may be referred to as discrete dimming. Another purpose is to provide the dummy bulb in place of a T12 bulb where other T12 bulbs are replaced with a T5 assembly (adapters plus T5 tube). The dummy bulb 10 may be formed to have the appearance of a regular working bulb—especially where the bulbs are installed in an open troffer or any lighting fixture where the bulbs are fully or partly visible.

In the most simplistic embodiment, the dummy 10 is formed of two terminals 1 and 2, and a connection 3 between the terminals 1, 2. Each of the terminals has a two-pin connector mounted to an end piece. The end pieces with the terminal pins will typically be rigidly connected so as to assure easy installation into the sockets and also the proper alignment of the terminal pins.

The connection 3 between the end pieces comprises a first wire 4 connected to a power pin 6 of the terminal 1 and a wire 5 connected to a power pin 7 of the terminal 2. The wires 4 and 5 are preferably formed of free-hanging wires, either insulated or open, but they may also be printed lines on the inside of the housing interconnecting the terminals 1 and 2. The wires 4 and 5 connect to a bridging circuit that is formed with a bank of capacitors 8 installed on a circuit carrier 9, such as a PCB. The capacitors 8 may be mounted with through-connections and back-soldering or they may be connected by surface-mounting. In either case, we provide for a plurality of capacitors 8, connected in series.

The individual capacitors of the series circuit may each be formed of more than one parallel-connected capacitors. This is based on the rule that the total capacitance of parallel-connected capacitors equals the sum of their individual capacitances (e.g., Qₜₒₜₐₗ=Q₁+Q₂ . . . ). The effective capacitance required in the context may be most cost-efficiently achieved by connecting less expensive smaller capacitors in parallel, as opposed to providing a single capacitor having a sufficient capacitance rating. The series connection of the capacitors 8 is based on the fact that the total capacitance of series-connected capacitors is expressed in the following formula 1/Qₜₒₜₐₗ=1/Q₁+1/Q₂ . . . . The series circuit becomes a high-pass filter that filters out any d.c. component and also an low-frequency flicker components. The primary purpose of the series-connected capacitors is to form a limiting circuit that is entirely transparent to the ballast and/or driving circuit. That is, the driving circuit of the light fixture does not feel any reactive difference between the fixture that is equipped with two active T5 bulbs or with one T5 bulb and one delamping dummy according to the invention. By way of example, a suitable capacitor is provided by Panasonic Electric Components as a “Cap film 2.2 μF, 250VDC Radial,” a through-hole mounted two-pin capacitor.

FIG. 2 is a plan view of a lighting fixture in a troffer 14 with a T5 fluorescent bulb 11 and a delamping dummy bulb 10 installed. The T5 bulb 11 is shorter than the T12. For example, the standard length 1200 mm (˜48 inches) T12 bulb finds its T5 equivalent with a length of 1148 mm (˜46 inches). That is, the T5 either requires a different fixture, or extender adapters. The adapters 12 and 13 are each approximately 25 mm in length and they provide for the physical/mechanical connection and the electrical connection to the terminals of the light fixture.

As noted above, our commonly assigned U.S. Pat. No. 7,936,129 B2 describes the conversion between the T12 and T5 fluorescent bulbs. In general, the kit includes adapters 12, 13 for bridging the spacing to the shorter tube as the T12 is replaced by a T5 bulb. The magnetic ballast of the T12 lamp is bypassed, and the power signal is up-converted to the higher frequency so as to power the high-frequency lamp. The earlier patent is incorporated by reference.

Further information concerning the drive circuit for the high-frequency lights and the conversion from the magnetic ballast circuit of the T12 to the newer T8 and T5 lights is found in our copending and commonly assigned patent application No. 13/447,720, filed Apr. 16, 2012, and in our international patent application PCT/US12/29732, filed Mar. 20, 2012. The prior applications are incorporated by reference as well.

1. A retrofit assembly for installing a high-frequency fluorescent lamp in a multi-bulb light fixture provided with first terminals for a first light bulb and second terminals for a second light bulb, the assembly comprising:
a high-frequency fluorescent bulb configured with physical dimensions to fit into the multi-bulb light fixture for connection to the first terminals of the multi-bulb light fixture;
a dummy bulb configured with physical dimensions to fit into the multi-bulb light fixture for connection to the second terminals of the multi-bulb light fixture, said dummy bulb having a bridging circuit connecting the second terminals to one another.

2. The assembly according to claim 1, wherein said high-frequency fluorescent bulb is a T5 fluorescent bulb with rapid start capability.

3. The assembly according to claim 1, wherein said T5 fluorescent bulb includes one or two end piece adapters for lengthening an effective length of said T5 fluorescent bulb to an equivalent length of a T12 fluorescent bulb.

4. The assembly according to claim 1, wherein said dummy bulb has a length corresponding to an equivalent length of a T12 fluorescent bulb.

5. The assembly according to claim 1, wherein said bridging circuit comprises a series circuit of a plurality of capacitors connected in series between respective power terminals of the second terminals.

6. A delamping dummy bulb for installation in a multi-bulb fluorescent light fixture configured for T12 fluorescent bulbs, comprising:
a first terminal having at least one terminal pin for connection to a power terminal of the light fixture, a second terminal having at least one terminal pin for connection to a power terminal of the light fixture, and a connecting body extending between and connecting said first and second terminals at a relative position corresponding to a relative position of first and second terminals of a T12 fluorescent bulb;
a bridging circuit electrically connected between said terminal pin of said first terminal and said terminal pin of said second terminal, said bridging circuit including a plurality of capacitors connected in series between said first and second terminals.

7. The delamping dummy bulb according to claim 6, wherein said capacitors of said bridging circuit are dimensioned to provide an equivalent resistance to a driving ballast of the light fixture when the delamping dummy is installed in place of a T12 fluorescent bulb.
